(19) United States
(12) Patent Application Publication
(10) Pub. No.: US 2010/0188220 A1
(43) Pub. Date: Jul. 29, 2010

(54) SECURITY ALARM SYSTEM

(76) Inventor: Darrick Boyd, Apache Junction, AZ (US)

Correspondence Address: SCHMEISER OLSEN & WATTS, 18 E UNIVERSITY DRIVE, SUITE # 101, MESA, AZ, 85201, US

(21) Appl. No.: 12/693,171

(22) Filed: Jan. 25, 2010

Related U.S. Application Data
(60) Provisional application No. 61/147,608, filed on Jan. 27, 2009.

(51) Int. Cl. G08B 13/14

(52) U.S. Cl. 340/568.1

(57) ABSTRACT

An alarm system is disclosed which notifies an owner when a personal item they have secured with the alarm system is moved or taken. The alarm system includes a notification device, wherein the notification device generates a notification output in response to being in an actuated state. The alarm system includes a switch coupled to the notification device, where the switch places the notification device in a non-actuated state in response to receiving pressure from an item to be secured. If the item being secured is moved or tampered with, a notification output is created which notifies the owner that their personal item may be in danger. The notification output can be an audible sound or a visible light or a signal to a cell phone or a wireless signal.

### CROSS REFERENCE TO RELATED APPLICATION

This application claims priority to U.S. Provisional Patent Application to Darrick Boyd entitled “Security Alarm System,” Ser. No. 61/147,608, filed Jan. 27, 2009, the disclosure of which is hereby incorporated entirely herein by reference.

### BACKGROUND OF THE INVENTION

1. Technical Field

This invention relates generally to security alarms to deter theft and more specifically to portable personal security alarms which can be used to notify the owner when a personal item they have secured with the invention has been moved, taken, or tampered with.

2. State of the Art

Theft of personal property is a common problem. One method of securing personal items is to lock them in a house, garage, or other secure facility. In this way a thief cannot get to the personal items to take them. Automobiles usually have locks and have additionally been equipped with alarms which make noise to notify the owner and the thief that the automobile is being tampered with. For items we take with us away from the house, car, or other secure facility there are several options. There are sometimes lockers available for safe storage of items. Lockers are not available everywhere, however, and are absent in remote areas such as campgrounds and other outdoor areas. Another option is to use chains and locks to secure personal items. Chains and locks can be defeated, however, and they do not typically notify the owner when this happens. It is desirable to have a portable alarm system which can be used to secure personal items, and which notifies the owner if their personal property has been moved or tampered with.

### DISCLOSURE OF THE INVENTION

This invention relates generally to security alarms to deter theft and more specifically to portable personal security alarms which can be used to notify the owner when a personal item they have secured with the invention has been moved, taken, or tampered with.

An alarm system is disclosed which includes a notification device, wherein the notification device generates a notification output in response to being in an actuated state, and generates no notification output in response to being in a non-actuated state. The alarm system includes a switch coupled to the notification device, where the switch places the notification device in a non-actuated state in response to receiving pressure from an item to be secured. The notification output can be an audible sound or a visible light or a signal to a cell phone or a wireless signal. In some embodiments the notification device is an electronic buzzer and a battery, where the buzzer is connected to the battery through the switch. In some embodiments the switch is contained in an enclosure with a lid, wherein the switch places the notification device in an actuated state in response to the lid being open. In some embodiments the enclosure contains an item to be secured.

An alarm system is disclosed, wherein the alarm system includes a notification device. The notification device generates a notification output in response to being in an actuated state, and generates no notification output in response to being in a non-actuated state. The alarm system includes an enclosure with a lid, wherein the lid is biased in the open position, and a switch coupled to the lid, wherein the switch places the notification device in an actuated state in response to the lid being open, and the switch places the notification device in a non-actuated state in response to the lid being closed. The lid is held closed by pressure from an item to be secured. In some embodiments the enclosure contains the notification device. In some embodiments the enclosure contains an item to be secured. In some embodiments the lid is biased in the open position with a spring.

A method of securing an item is disclosed which includes activating an alarm system, closing a lid of an enclosure of the alarm system, wherein closing the lid places a notification device in a non-actuated state, and holding the lid closed using pressure from an item to be secured. In some embodiments the notification device is placed in an actuated state in response to removing the pressure on the lid from the item to be secured. The notification device creates a notification output in response to being in the actuated state. In some embodiments the notification output is an audible sound. In some embodiment the notification output is a signal to a wireless device.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a front perspective view of alarm system 10 according to the invention with notification device 30 in an actuated state (lid 11 open).

FIG. 2 is a perspective view of alarm system 10 of FIG. 1 with notification device 30 in a non-actuated state (lid 11 closed), and with pressure 17 from item to be secured 16 holding lid 11 closed and maintaining notification device 30 in the non-actuated state.

FIG. 3 is a rear perspective view of alarm system 10 of FIG. 1 with notification device 30 in a non-actuated state (lid 11 closed).

FIG. 4 is a schematic of one embodiment of alarm system 10 according to the invention.

FIG. 5 is a schematic of alarm system 10 of FIG. 1.

FIG. 6 is a perspective view of another embodiment of alarm system 10 according to the invention.

FIG. 7 illustrates method 200 of securing an item according to the invention.

### DETAILED DESCRIPTION OF EMBODIMENTS OF THE INVENTION

As discussed above, embodiments of the present invention relate to security alarm systems and more particularly to personal portable alarms which can be carried on the person and used to notify the owner when personal property has been moved.

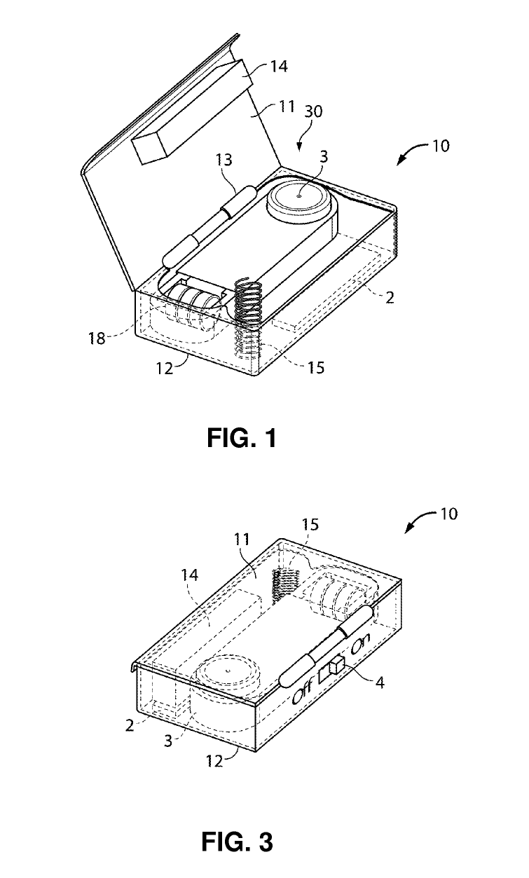

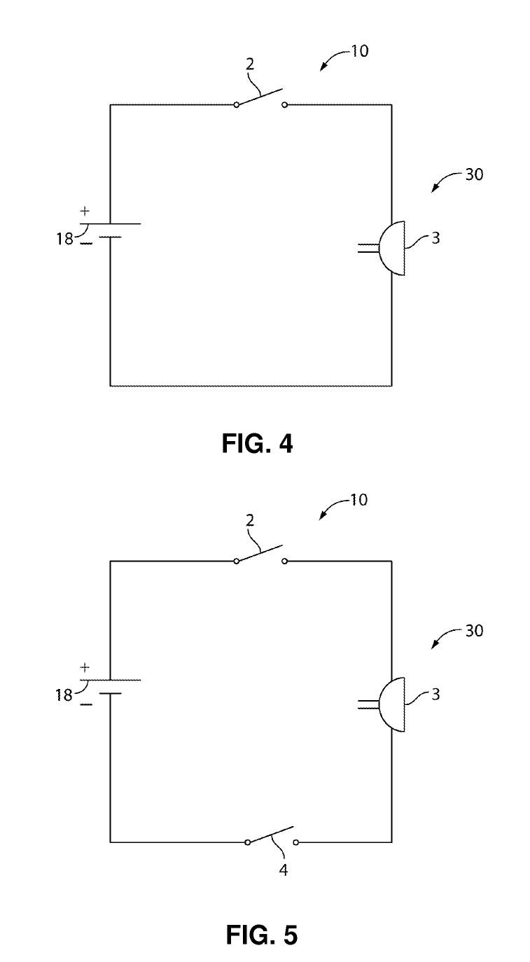

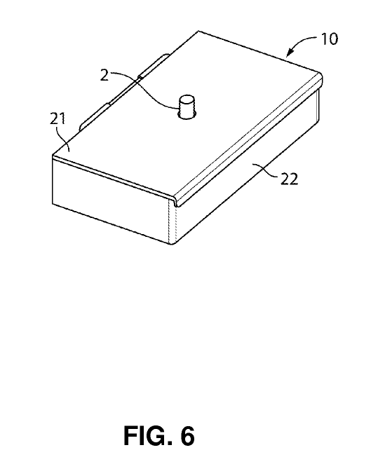

FIG. 1 through FIG. 3 show an embodiment of alarm system 10 according to the invention. FIG. 4 shows a schematic embodiment of alarm system 10 according to the invention. FIG. 5 shows a schematic embodiment of alarm system 10 of FIG. 1. FIG. 6 shows an additional embodiment of alarm system 10 according to the invention. Alarm system 10 according to the invention as shown in perspective view in FIG. 1 includes notification device 30 and switch 2. Notification device 30 provides a notification output when it is in an actuated state, and provides no notification output when it is in a non-actuated state. A notification device is any device which is used to provide notification to the owner of an item to be secured that the item they have secured with alarm system 10 has been moved or tempered with. Notification device 30 is some embodiments is an electronic buzzer. Notification device 30 in some embodiments is a light source such as an LED or a light bulb. Notification device 30 in some embodiments is a transmitter which sends a wireless signal. An actuated state in this document means notification device 30 is in a state wherein it is creating a notification output. The notification output can be noise, light, an electrical signal, a wireless signal, or any other type of output which can be used to provide notification to an owner that an item they are trying to secure has been tampered with.

FIG. 4 shows a schematic embodiment of alarm system 10 with notification device 30 and switch 2. In this embodiment notification device 30 includes buzzer 3 and batteries 18. When buzzer 3 is provided power by batteries 18, then buzzer 3 makes a loud sound. In this embodiment, notification device 30 makes an audible sound when notification device 30 is in an actuated state—ie when buzzer 3 is powered by batteries 18. When switch 2 is closed, buzzer 3 is in an actuated state (powered by batteries 18) and generates a loud sound. When switch 2 is open, buzzer 3 is in a non-actuated state (no power received) and buzzer 3 is silent in response. FIG. 5 shows a schematic of alarm system 10 as shown in FIG. 1 through FIG. 3, which includes activation switch 4. Activation switch 4 will be discussed shortly.

Switch 2 in this embodiment is a magnetic switch, and is opened and closed by magnet 14, which is attached to lid 11 of enclosure 12. In this way switch 2 is coupled to lid 11. When lid 11 of enclosure 12 is closed, magnet 14 is near switch 2, close enough for switch 2 to be opened by the magnetic fields of magnet 14. In this way switch 2 is opened in response to lid 11 being in the closed position. In this embodiment of alarm system 10, switch 2 is closed when magnet 14 is not nearby—ie when magnet 14 is too far away for the magnetic fields from magnet 14 to affect switch 2. In this way switch 2 is closed when lid 11 is open. When lid 11 of enclosure 12 is open, magnet 14 is moved away from switch 2, switch 2 closes in response, buzzer 3 is placed in an actuated state because it receives power from batteries 18, and buzzer 3 produces a notification output which in this embodiment is an audible sound. In this way switch 2 places notification device 30 in an actuated state when lid 11 is open. FIG. 1 shows a perspective view of alarm system 10 according to the invention, where notification device 30 is in an actuated state. Lid 11 is open, switch 2 closes in response to lid 11 being open, buzzer 3 is powered by batteries 18 in response to switch 2 being closed, and buzzer 3 makes a loud noise in response to being powered by batteries 18. In this way notification device 30 is placed in an actuated state in response to lid 11 being open.

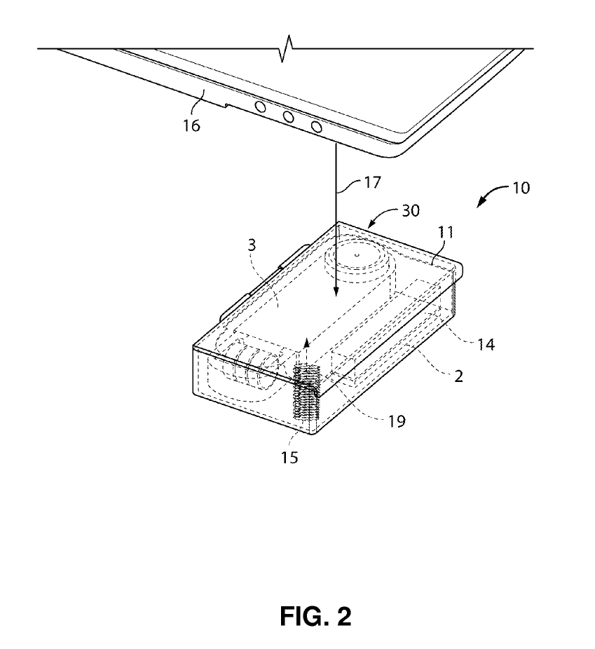

FIG. 2 shows a perspective view of alarm system 10 of FIG. 1, where notification device 30 is in a non-actuated state. In this situation lid 11 is closed, which places magnet 14 near switch 2. Switch 2 opens in response to magnet 14 being nearby. When switch 2 opens, notification device 30, which in this embodiment comprises buzzer 3 and batteries 18, are electrically disconnected in response to switch 2 being open. Notification device 30, comprising buzzer 3 and batteries 18, are placed in a non-actuated state in response to lid 11 being closed. In this way switch 2 places notification device 30 in a non-actuated state in response to lid 11 being closed.

Spring 15 acts to bias lid 11 in the open position. Spring 15 is exerting pressure 19 on lid 11. Lid 11 is held closed by pressure 17 from an item to be secured, which in this embodiment is laptop computer 16, as shown in FIG. 2. As long as laptop computer 16 is exerting a pressure 17 on lid 11, wherein pressure 17 is greater than pressure 19 exerted by spring 15, lid 11 will remain closed and notification device 30 will be in a non-actuated state. If laptop computer is removed such that it no longer exerts pressure 17 on lid 11, pressure 19 from spring 15 will push lid 11 open, and notification device 30 will be placed in an actuated state. Notification device 30, comprising buzzer 3 and batteries 18, will make a loud noise in response to loss of pressure from item to be secured 16 on lid 11.

Alarm system 10 is used to notify the owner when item to be secured 16 is moved. The owner of item to be secured 16, which in this embodiment is laptop computer 16, wants to leave laptop computer 16 unattended for a short time, so they place laptop computer 16 on top of alarm system 10, such that laptop computer 16 is exerting pressure on lid 11 and holding lid 11 closed. When a thief tries to steal laptop computer 16, laptop computer 16 is removed from on top of alarm system 10, causing lid 11 to open in response to pressure 19 from spring 15, and buzzer 3 will make a loud noise in response. The owner will hear the buzzer and can take action against the thief.

It is to be understood that alarm system 10 can be used to protect many types of items to be secured, such as purses, wallets, phones, keys, bags, vehicles, motorcycles, all-terrain vehicles, etc. Any item which can be configured such that it holds lid 11 closed while secure, and allows lid 11 to open when moved or tampered with, can be secured with alarm system 10.

FIG. 3 shows a rear perspective view of alarm system 10 showing activation switch 4. FIG. 5 shows a schematic of alarm system 10 including activation switch 4. Activation switch 4 is used as an On/Off switch. When switch 4 is in the “on” position, switch 4 is closed and alarm system 10 is activated. In the activated state, notification device 30 is actuated when switch 2 is closed and not actuated when switch 2 is open. If switch 2 is coupled to lid 11 as shown in FIG. 1 through FIG. 3, when switch 4 of alarm system 10 is in the activated state notification device 30 is actuated when lid 11 is open and not actuated when lid 11 is closed. When switch 4 is in the “off” position, switch 4 is open, and notification device 30 is in a non-actuated state regardless of whether lid 11 or switch 2 is open or closed. Activation switch 4 is used to turn off alarm system 10 when it is not being used. When activation switch 4 is turned off, alarm system 10 is de-activated and can be carried in purse or pocket, for instance and will not sound an alarm if lid 11 opens accidentally, for example.

FIG. 6 shows a perspective view of a further embodiment of alarm system 10 according to the invention. In this embodiment switch 2 directly controls actuation of notification device 30. Notification device 30 is enclosed in enclosure 22, which has lid 21 which remains closed. Enclosure 22 contains notification device 30, which in this embodiment is buzzer 30 and batteries 18, connected as shown in FIG. 4. Lid 11 is not involved in the actuation of notification device 30 in this embodiment of FIG. 6. In this embodiment switch 2 is a pressure switch, which is open when pressure is placed on switch 2, and closed when there is no pressure on switch 2. Item to be secured 16 is secured by placing pressure from item to be secured 16 on switch 2, which opens switch 2 and places notification device 30 in a non-actuated state. If item to be secured 16 is moved such that it no longer puts pressure on switch 2, switch 2 closes, which places notification device 30 in an actuated state, which in this embodiments would result in buzzer 3 making a loud sound to notify the owner that item to be secured 16 may be in danger. In this way switch 2 places notification device 30 in a non-actuated state in response to receiving pressure from an item to be secured. Switch 2 places notification device 30 in an actuated state when no pressure is received on switch 2.

Notification device 30 in the discussed embodiments produces a notification output that is an audible sound. Notification device 30 is a piezoelectric buzzer in some embodiments. In some embodiments notification device 30 makes a notification output that is visible light. A notification output which is visible light is desired for applications where visual notification is desired. Notification output in some embodiments is a wireless signal that is sent to a cell phone so the owner of item to be secured 16 gets a call when notification device 30 is actuated. Notification output in some embodiments is a wireless signal that is sent to a computer or other device so the owner of item to be secured 16 gets an email when notification device 30 is actuated. In some embodiments notification device 30 is a transmitter which alarms a receiver that is in the owner's possession. The receiver can be a cell phone, a pager, a personal digital assistant, a laptop, or other personal device. Notification device 30 in some embodiments is a battery-powered buzzer. In some embodiments notification device 30 is powered by means other than batteries. The notification output can be a voice played through a speaker, or a device which generates a loud amplified screech or wail. Notification device 30 can be any method of creating a notification output, and a notification output can be any means for signaling to the owner that item to be secured 16 is no longer maintaining notification device 30 in a non-actuated state, and may be in danger.

In this embodiment notification device 30, switch 2, magnet 14, and spring 15 are all contained in enclosure 12. In some embodiments the components can be divided into multiple enclosures. Electrical interconnections can be hard-wired or wireless interconnections as is known in the art. For example, enclosure 12 in one embodiment contains switch 2, magnet 14 and spring 15 as shown in FIG. 1, but notification device 30 is contained in a separate enclosure. Notification device 30 is wirelessly interconnected to switch 2. In this embodiment notification device 30 is carried by the owner of item to be secured 16, while enclosure 12 with lid 11 that provides actuation of notification device 30 is with item to be secured 16 as discussed previously. If item to be secured 16 is moved, switch 2 places notification device 30—which is being carried with the owner of item to be secured 16—in an actuated state. Notification device 30 produces a notification output in response to being placed in an actuated state. In this embodiment the notification output is produced where the owner is instead of where item to be secured 16 is. This may be desirable where the owner is not physically close to item to be secured 16 and does not want to rely on hearing a buzzer from some distance away, for example. In some embodiments a notification output is produced in more than one location, such as at the location of item to be secured 16 and with the owner.

In some embodiments of alarm system 10, enclosure 12 or enclosure 22 can be made to contain items to be secured. In some embodiments enclosure 12 or enclosure 22 is made to contain rings, jewelry, or money. In some embodiments enclosure 12 or enclosure 22 is made rugged so that it can be used with a vehicle such as a car, a motorcycle, or an all-terrain vehicle. Alarm system 10 is placed under the wheel of the vehicle, for example. Notification device 30 would in this embodiment be placed in an actuated state if the vehicle were moved, releasing pressure on switch 2 or lid 11.

FIG. 4 and FIG. 5 show two possible schematic embodiments of alarm system 10. It is to be understood that many improvements or variations on these schematics are possible. More than one battery 18 can be used if a higher voltage or more current is desired. Other types of power sources different from batteries are used in some embodiments. One or more additional switches are used to hold alarm system 10 in different states in some embodiments. Each of the one or multiple switches can be equipped with delays, so that the owner has some amount of time to get item to be secured 16 armed and secured with alarm system 10 without actuating notification device 30 and/or notification device 30 will not sound for a certain amount of time after closing of switch 2 to give the owner time to readjust or move the item without setting off the alarm. The switches can be any known variety which provide the desired function. Switch 2 can be a magnetic switch such as a reed switch. Switch 2 can alternatively be a pressure switch. Any switch configuration can be used according to the invention which will allow notification device 30 to be placed in an actuated state when item to be secured 16 is moved. The schematic embodiments shown in FIG. 4 and FIG. 5 can be increased in complexity and sophistication as desired to add features and/or reliability to the alarm. Additional electronic components such a resistors, capacitors, transistors, and controllers can be used to add functionality, change sound tones generated, store voice or music tones, for instance. Transmitters and receives can be added as is known in the art to provide wireless signals, wireless notification output, and/or wireless interconnections.

In some embodiments alarm system 10 is designed with smart switches which deter the thief from turning off notification device 30 once notification device 30 has been actuated. In the embodiments shown the thief can turn off notification device 30 by closing lid 11 or putting pressure on switch 2 or turning off switch 4. In some embodiments intelligence is added to alarm system 10 such that once alarm system 10 is armed and then notification device 30 is actuated, notification device 30 cannot be turned off without re-setting alarm system 10 in some way that only the owner is aware of. A smart power sequence is used in some embodiments, such that alarm system 10 is re-set by a power-down and turn-on sequence. In some embodiments the notification device can be placed in a non-actuated state after actuation in response to a programmed series of button pushes which only the owner knows. Or in another embodiment, multiple switches are used which re-set alarm system 10 when actuated. In another embodiment dummy switches are used to confuse the thief about how to turn alarm system 10 off. This will make it less likely that the thief can turn off alarm system 10.

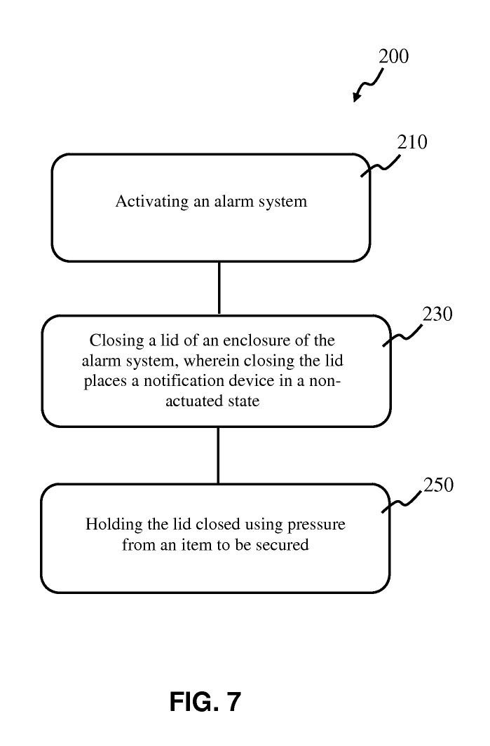

FIG. 7 illustrates a method of securing an alarm system 200 which includes step 210 activating an alarm system, and step 230 closing a lid of an enclosure of the alarm system, wherein closing the lid places a notification device in a non-actuated state. Method 200 includes step 250 holding the lid closed using pressure from an item to be secured. Method 200 can include many other steps. In some embodiments method 200 includes driving a vehicle such that the wheel of the vehicle is holding the lid closed. Step 210 activating an alarm system can comprise closing an on/off switch. In some embodiments of method 200 the lid is placed in an open position when pressure from an item to be secured is removed, which places the notification device in an actuated state in response. In some embodiments of step 230 the notification device generates a notification output in response to being in an actuated state, and generates no notification output in response to being in a non-actuated state. In some embodiments the notification output is audible sound. In some embodiment the notification output is a signal to a wireless device. In some embodiments other type of notification outputs are generated.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, the size and shape of alarm system 10 can be designed for specific purposes or tastes. The type of noise or other notification output can be tailored for specific needs.

1. An alarm system comprising:
a notification device, wherein the notification device generates a notification output in response to being in an actuated state, and generates no notification output in response to being in a non-actuated state; and
a switch coupled to the notification device, wherein the switch places the notification device in a non-actuated state in response to receiving pressure from an item to be secured.

2. The alarm system of claim 1, wherein the notification output is audible sound.

3. The alarm system of claim 1, wherein the notification device comprises:
an electronic buzzer; and
a battery, wherein the electronic buzzer is connected to the battery through the switch.

4. The alarm system of claim 3, wherein the notification device, the buzzer, and the switch are contained in an enclosure with a lid, wherein the switch places the notification device in an actuated state in response to the lid being open, and the switch places the notification device in a non-actuated state in response to the lid being closed.

5. The alarm system of claim 1, wherein the switch is contained in an enclosure with a lid, wherein the switch places the notification device in an actuated state in response to the lid being open.

6. The alarm system of claim 5, wherein the enclosure contains an item to be secured.

7. The alarm system of claim 1, wherein the lid is biased in an open position with a spring.

8. An alarm system comprising:
a notification device, wherein the notification device generates a notification output in response to being in an actuated state, and generates no notification output in response to being in a non-actuated state;
an enclosure with a lid, wherein the lid is biased in the open position; and
a switch coupled to the lid, wherein the switch places the notification device in an actuated state in response to the lid being open, and the switch places the notification device in a non-actuated state in response to the lid being closed;
wherein the lid is held closed by pressure from an item to be secured.

9. The alarm system of claim 8, wherein the notification output is visible light.

10. The alarm system of claim 8, wherein the notification output is a signal to a cell phone.

11. The alarm system of claim 8, wherein the enclosure contains the notification device.

12. The alarm system of claim 8, wherein the enclosure contains an item to be secured.

13. The alarm system of claim 8, wherein the notification device is placed in a non-actuated state in response to a programmed series of button pushes.

14. The alarm system of claim 8, wherein the notification device comprises:
an electronic buzzer; and
a battery, wherein the battery powers the electronic buzzer through the switch.

15. A method of securing an item comprising:
activating an alarm system;
closing a lid of an enclosure of the alarm system, wherein closing the lid places a notification device in a non-actuated state; and
holding the lid closed using pressure from an item to be secured.

16. The method of claim 15, wherein the notification device is placed in an actuated state in response to removing the pressure on the lid from the item to be secured.

17. The method of claim 16, wherein the notification device generates a notification output in response to being placed in the actuated state.

18. The method of claim 15, wherein the notification device creates no notification output in response to being placed in the non-actuated state.

19. The method of claim 17, wherein the notification output is audible sound.

20. The method of claim 17, wherein the notification output is a signal to a wireless device.
